(19) United States
(12) Patent Application Publication
(10) Pub. No.: US 2026/0104394 A1
(43) Pub. Date: Apr. 16, 2026

(54) IN SITU REAL-TIME MONITORING OF RELIABILITY AND INTEGRITY TESTS BY MEANS OF ACOUSTIC EMISSION SENSORS

(71) Applicant: Infineon Technologies AG, Neubiberg (DE)

(72) Inventor: Rodrigo Carvalho Almeida, Muenchen (DE)

(21) Appl. No.: 19/312,075

(22) Filed: Aug. 27, 2025

(30) Foreign Application Priority Data
Oct. 11, 2024 (DE) 102024129397.7

(51) Int. Cl. G01N 29/14; G01N 29/44; G01S 5/30

(52) U.S. Cl. CPC G01N 29/14; G01N 29/4472; G01S 5/30; G01N 2291/0231; G01N 2291/0289

(57) ABSTRACT

A method is described that comprises providing a semiconductor device that is coupled to at least one acoustic sensor and modifying, during a training test, at least one first parameter of the semiconductor device. The method further comprises acquiring, by the at least one acoustic sensor, first sensor data that represent an acoustic emission of the semiconductor device, wherein the acoustic emission is linked to a failure of the semiconductor device that is at least partly caused by the modification of the at least one first parameter. The method also comprises associating characteristics of the acoustic emission of the semiconductor device to a type of failure based at least on the first sensor data.

This application claims priority to German Application Number 102024129397.7 filed on Oct. 11, 2024, the entire content of which is incorporated herein by reference.

### TECHNICAL FIELD

This application relates to the field of semiconductor devices and semiconductor packaged devices, in particular to the in situ monitoring of reliability and integrity tests of semiconductor devices.

### BACKGROUND

Semiconductor devices are widely used in the industry. However, they can be subject to unexpected failures that may endanger the whole system in which they are used. For example, one or several layers of a semiconductor device may delaminate or a crack may occur at one or several locations of the device. It is thus important to understand the physical nature a failure (the failure mode) and its cause in order to be able to predict a failure and prevent a failure of the whole system. This is usually done by carrying out reliability and integrity tests, during which the device under test is subjected to changes of the environment and monitored.

Known solutions for monitoring the device under test involve the use of cameras that take pictures of the semiconductor device at regular intervals. However, these monitoring methods are not able to detect failures modes that occur within the device. Detection is only possible when the failure reaches the surface of the device. At this time, the device may already have become completely unusable and the various stages of the failure mode cannot be observed. An internal analysis is also possible, but involves interrupting the test, disassembling the device from the test bench for inspection and re-assembling it afterwards. These operations are extremely time-consuming and costly.

Accordingly, a need for monitoring a semiconductor during a test has been identified that makes it possible to continuously monitor failure modes in real-time and in situ so as to be able to issue warnings about the occurrence of these failure modes.

### SUMMARY

In one example, the disclosure is directed to a method comprising the steps of: providing a semiconductor device that is coupled to at least one acoustic sensor; modifying, during a training test, at least one first parameter of the semiconductor device; acquiring, by the at least one acoustic sensor, first sensor data that represent an acoustic emission of the semiconductor device, wherein the acoustic emission is linked to a failure of the semiconductor device that is at least partly caused by the modification of the at least one first parameter; and associating characteristics of the acoustic emission of the semiconductor device to a type of failure based at least on the first sensor data.

In another example, the disclosure is directed to a method comprising the steps of: providing a semiconductor device that is coupled to at least one acoustic sensor; outputting, by the at least one acoustic sensor, a sensor signal representing an acoustic emission of the semiconductor device; and based on at least the sensor signal: detecting the presence of a failure of the semiconductor device and, in the event that the presence of a failure is detected, determining a type of failure.

In one example, the disclosure is directed to a system comprising a semiconductor device, at least one acoustic sensor and a processor. The at least one acoustic sensor is coupled to the semiconductor device and configured to output a first sensor signal representing an acoustic emission of the semiconductor device. The processor is configured to receive, as input, at least the first sensor signal, and based on at least the first sensor signal: detect the presence of a failure of the semiconductor device and, in the event that the presence of a failure is detected, determine a type of failure.

### BRIEF DESCRIPTION OF THE DRAWINGS

The embodiments described herein can be better understood with reference to the following description and drawings. The components in the figures are not necessarily to scale, emphasis instead being placed upon illustrating the principles of the embodiments. Furthermore, in the figures, like reference numerals designate corresponding parts. In the drawings:

FIG. 1 illustrates a first example of a system for monitoring failures in a semiconductor device during a passive test, in accordance with one or more techniques described herein.

FIG. 2 illustrates a second example of a system for monitoring failures in a semiconductor device during an active test, in accordance with one or more techniques described herein.

FIG. 3 illustrates a third example of a system for monitoring and locating failures in a semiconductor device, in accordance with one or more techniques described herein.

FIG. 4 illustrates a first example of a semiconductor device that is coupled to an acoustic sensor in a side view, in accordance with one or more techniques described herein.

FIGS. 5A and 5B illustrates a second example of a semiconductor device that is coupled to a plurality of acoustic sensors, in accordance with one or more techniques described herein, FIG. 5A is a view from above and FIG. 5B is a side view.

FIG. 6 illustrates a third example of a semiconductor device that is coupled to an acoustic sensor in a side view, in accordance with one or more techniques described herein.

FIGS. 7A and 7B illustrates an example of a sensor signal during a burst event with FIG. 7A showing the time domain and FIG. 7B showing the frequency domain.

FIG. 8 is a flowchart illustrating a first example method for creating a predictive model for predicting failure modes in a semiconductor device, in accordance with one or more techniques described in this disclosure.

FIG. 9 is a flowchart illustrating a second example method for predicting failure modes in a semiconductor device, in accordance with one or more techniques described in this disclosure.

### DETAILED DESCRIPTION

When a semiconductor device is stressed (be it intentionally or unintentionally) because of changes in the environment, several failure modes may occur. For example, cracks may appear at various locations of the device, such as at the bottom or at the top of the semiconductor device, or at the gate of a transistor of the device. Some of the device layers may delaminate. These defects can also occur simultaneously. In the worst case, they can propagate such that they can lead to the failure of the complete semiconductor device. Understanding these failure modes may help predict them and manufacture devices that are less prone to failures.

In order to monitor the failure modes occurring in semiconductor devices, the semiconductor devices are submitted to tests during which one or several parameters of the environment may be modified. For example, the temperature of a closed environment, in which the device is arranged, may be controlled according to a predetermined pattern during a thermal cycling process. In another example, a voltage or a current is applied to the device, wherein the voltage or current is controlled according to a predetermined pattern during a power cycling process. In a further example, a humidity or moisture of the environment of the device is controlled according to a predetermined pattern. These tests, also called reliability or integrity tests, may lead to the occurrence of failure modes in the device. The device under test is usually monitored by measuring one or several parameters of the device during the test. For example, electrical or thermal parameters may be monitored.

Unfortunately, usual monitoring techniques do not make it possible to continuously monitor the failure modes during reliability tests in situ and in real-time. In particular, some failure modes have no influence on the monitored parameters and, therefore, cannot be detected. Further, the failure modes, such as internal cracks or delamination in molded packages, are internal to the device under test and may only become manifest at the surface of the device at an advanced stage. The evolution of the failure modes can, thus, not be followed. In addition, failure modes may occur in non-accessible areas. For example, bottom cracks that occur at the bottom of the device may be hidden by a cooling plate or by the test setup.

In order to properly detect and investigate the failure modes of the semiconductor device, one solution would be to temporarily interrupt the test to carry out an extensive analysis of the device under test, for example via optical inspection, acoustic scan microscopy, or x-ray analysis. This leads to undesirable handling, such as disassembling the device under test from the test equipment, sending it to inspection, re-assembling the device under test in the equipment and resuming the test. These operations require a high idle time and an intensive manpower. They also have an impact on the duration of the test and may lead to additional failures due to the handling and cycles of stop/restart of the test.

Because of these limitations, the detailed inspection of the device under test is usually carried out only at the end of the test. By this time, the damage to the device is already too harsh to allow a clear understanding of the chain of events leading to the failure and of the source of origin of the failure. In many cases, there are competing failure modes in the device so that it is no longer possible to know which failure mode is the main trigger of the device failure. Only intermediate read-outs make it possible to observe the beginning of the failure mode and, thus, to warn about the occurrence of these failure modes.

As an alternative, it is known to monitor the device under test by means of cameras that take pictures of the device at regular intervals, or by using infrared thermography. However, these methods also fail to solve the problem of monitoring internal or hidden failure modes because these failure modes can only be detected when they reach the top surface of the device.

Acoustic emission analysis is a non-destructive technique that makes it possible to continuously monitor mechanically or thermally stressed components in real time and in situ. When a thermo-mechanical stress is applied to a material, the material deforms elastically. When the stress is sufficiently high, this might lead at highly stressed locations to the apparition of a crack or of another failure in the material. The failure leads to the generation of an elastic wave that propagates through the material and can be detected by acoustic sensors.

By monitoring acoustic emissions of a semiconductor device during a test, it is possible to detect and locate a failure in the device. By using the information from the acoustic emission signal alone or in combination with information coming from other sources, it is possible to establish and detect patterns in the failure modes as well as train algorithms to classify signal and predict failure modes accurately. In one example, the acoustic emission analysis of the semiconductor device is combined with machine learning algorithms to classify failure modes of the semiconductor device.

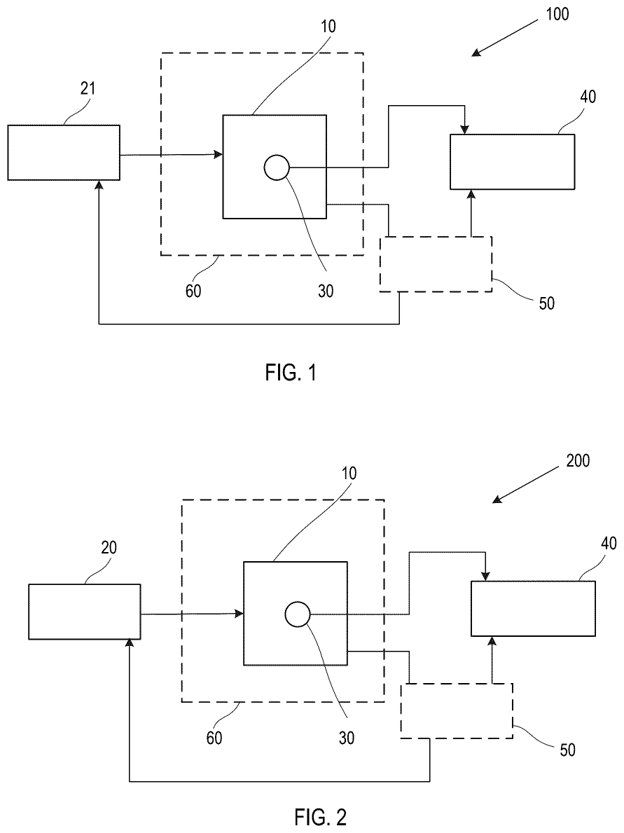

FIG. 1 shows a first example of a system 100 for monitoring failure modes in a semiconductor device 10. The semiconductor device 10 is coupled to at least one acoustic sensor 30, for example via an acoustic coupler, as will be explained on more detail below with reference to FIG. 4. The at least one acoustic sensor 30 is configured to measure acoustic emissions of the semiconductor device 10 and to output a corresponding sensor signal representing the acoustic emission. The acoustic sensor 30 is arranged such that it is able to detect acoustic waves emitted by the semiconductor device 10 when it is submitted to stress, which can be caused by various physical influencing variables. In the example depicted in FIG. 1, the semiconductor device 10 is coupled to only one acoustic sensor 30. The acoustic sensor 30 is arranged at the center of the semiconductor device 10 on a top surface of the semiconductor device 10. The acoustic sensor may be arranged differently. In one example, the acoustic sensor 30 is arranged at one edge of the semiconductor device 10. In another example, the acoustic sensor 30 is arranged on an interposer 70 that is coupled to the semiconductor device 10. The acoustic sensor 30 may be a piezo-electric sensor that converts vibrations of the semiconductor device 10 into an electrical signal. In one example, the acoustic sensor 30 is a piezo-acoustic sensor having a flat frequency response between 100 and 400 kH. The frequency response of the acoustic sensor 30 may be different depending on the type of semiconductor device 10, the materials used in the system 100 and the failure modes under study.

The semiconductor device 10 may be a module, a discrete device or an integrated circuit chip and may comprise at least one transistor. In one example, the semiconductor device 10 is a packaged power semiconductor component, wherein the circuits of the semiconductor device are enclosed in a casing and the package comprises a plurality of connections for connecting to another device, such as a printed circuit board.

The system 100 further comprises a data acquisition device 40 that is coupled to the acoustic sensor 30, for example via a cable. The data acquisition device 40 may comprise at least one microprocessor that is configured to perform at least some of the functions of the data acquisition device 40. The data acquisition device 40 is configured, based on the sensor signal sent by the acoustic sensor 30, to detect the presence of a failure in the semiconductor device 10 and, in the event that the presence of a failure is detected, determine a type of failure. The function and purpose of the data acquisition device 40 is further discussed below.

The system further comprises a control device 21 that is configured to control at least on parameter of the semiconductor device 10. In one example, the control device 21 is configured to control a temperature of the semiconductor device 10. In another example, the control device 21 is configured to control a moisture or a humidity of the environment in which the semiconductor device 10 is arranged. The humidity is the concentration of water vapor in the environment. During a test, the control device 21 is configured to control the at least one parameter according to a predefined pattern. In one example, the predefined pattern is defined by a user via a man-machine-interface. In one example, the predefined pattern comprises a plurality of identical cycles, wherein, during each cycle, the control device 21 is configured to vary the parameter between a minimum and a maximum. In another example, the control device 21 is configured to simulate real application conditions of the semiconductor device 10.

The semiconductor device 10 may be arranged in a closed chamber 60. This makes it easier to control the parameters of the environment of the semiconductor device 10, such as moisture and temperature.

When a failure mode occurs in the semiconductor device 10, acoustic waves (acoustic emissions) are emitted that are linked to the failure mode. In particular, the acoustic emissions are characteristic of the type of failure and of the location of the failure in the semiconductor device 10. It is thus possible to gain insight on the failure modes by monitoring and analyzing the acoustic emissions measured by the acoustic sensor 30. Measuring acoustic emissions is a non-destructive and relatively low cost test technique that allows an in situ detection and monitoring of failure modes. In particular, all failure modes lead to acoustic emissions, so that even internal cracks and hidden failure modes, which would not visible with an optical camera, can be monitored. The acoustic sensor 30 thus allows an early detection of failure modes.

In one example, the system 100 comprises at least one further sensor 50, which is optional and represented with dotted lines in FIG. 1. The at least one further sensor 50 is configured to monitor one or more parameters of the semiconductor device and to output a second sensor signal to the data acquisition device 40. In one example, the further sensor 50 is a temperature or a humidity sensor. In another example, the further sensor 50 is configured to measure an electrical parameter of the semiconductor device 10, such as a current flowing though the semiconductor device 10 or a voltage between terminals of the semiconductor device 10. The further sensor 50 may be directly coupled to the semiconductor device 10 or may be placed within the same housing as the semiconductor device 10. The further sensor 50 is configured for in situ monitoring. In one example, the further sensor 50 is coupled to the control device 21 and the control device 21 controls the at least one parameter of the semiconductor device 10 based on the output of the at least one further sensor 50.

In one example, the data acquisition device 40 is configured to detect, based on the sensor signal sent by the acoustic sensor 30 and on the at least one further signal output by the at least one further sensor 50, the presence of the failure and, in the event that the presence of a failure is detected, determine the type of failure. The further sensor 50 is thus configured to provide the data acquisition device 40 with further information regarding the failure modes of the semiconductor device 10 which may help classify the failure modes and associate them with a particular burst event of the sensor signal of the acoustic sensor 30. In addition, the further sensor 50 makes it possible to control the environment of the semiconductor device 10.

The system 100 of FIG. 1 works as follows: The control device 21 applies a thermo-mechanical stress to the semiconductor device 10, wherein stress may also be caused by humidity. In one example, the control device 21 modifies at least a parameter of the semiconductor device 10, such as temperature or moisture. The stress provoked by the modification of the parameter eventually leads to the generation of at least one failure in the semiconductor device 10, such as a crack or a delamination. The failure leads to the emission of acoustic waves by the semiconductor device 10. The acoustic sensor 30, which is coupled to the semiconductor device 10, outputs, as a response to the acoustic emissions, a sensor signal that is sent to the data acquisition device 40. The sensor signal may be a time signal or a frequency signal. When a failure occurs or propagates through the semiconductor device 10, this results in a transient time signal (burst) that can be detected by the acoustic sensor 30 and analyzed. The time signal of the sensor 30 comprises a plurality of transient signals, which may or may not be associated with a particular type of failure. The data acquisition device 40 is configured to detect, based on the sensor signal generated by the acoustic sensor 30, the presence of a failure and, in the event that the presence of a failure is detected, determine a type of failure. In one example, the data acquisition device 40 is configured to correlate the sensor signal from the acoustic sensor 30, in particular to correlate at least one characteristic of the sensor signal, to at least one specific failure mode of the semiconductor device 10. In one example, the data acquisition device 40 is configured to apply a Fourier transform to a time signal of the acoustic sensor 30, in particular to at least some of the transient parts of the time signal, in order to obtain further information on the failure mode.

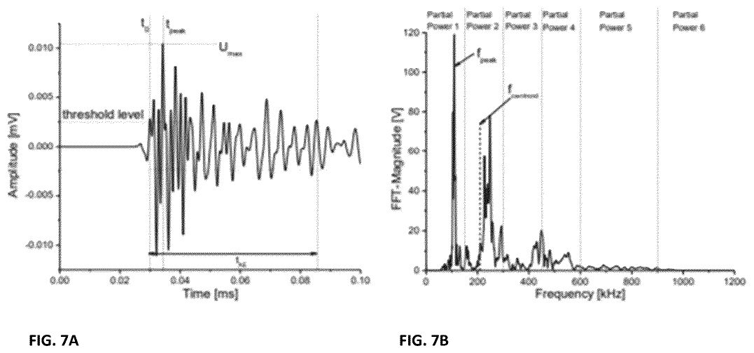

FIG. 7(a) shows an example of a graph depicting the amplitude of a sensor signal of the acoustic sensor 30 in the time domain (i.e. signal amplitude over time during a burst event). FIG. 7(b) shows the magnitude of this sensor signal after application of the Fourier transform depending on frequency. A transient signal, or burst, is detected in the time signal, which may correspond to one or several failure events in the semiconductor device 10. The transient signal can then be translated into the frequency domain to obtain further information on the possible failure event, as shown in FIG. 7(b).

In one example, in order to evaluate the sensor signal, the data acquisition device 40 is configured to extract or calculate at least one acoustic parameter based on the sensor signal. The acoustic parameter may be extracted from the signal in the time domain or in the frequency domain. In one example, the at least one acoustic parameter is at least one of: a burst signal peak amplitude, a burst signal rise-time, a ring-down count, a signal duration, an average frequency, a reverberation frequency, an initiation frequency, a peak frequency, a spectral centroid, a weighted peak frequency, and a partial power in a given frequency range. The parameters are discussed in more detail below.

The burst signal peak amplitude is the peak amplitude of a burst event of the sensor signal in the time domain. In FIG. 7(a), this corresponds to the peak amplitude Uₘₐₓ of the time signal at tₚₑₐₖ.

The burst signal rise-time is the time difference between the time at which the maximum amplitude of the signal during the burst event is reached and the time at which the amplitude of the signal exceeds a predefined threshold level for the first time. In the example of FIG. 7(a), it is equal to t₀-tₚₑₐₖ, wherein t₀ is the time at which the amplitude of the signal exceeds the threshold level for the first time and tₚₑₐₖ is the time at which the peak amplitude Uₘₐₓ is reached.

The ring-down count is the number of times N_{AE} that the acoustic emission transient signal crosses the detection threshold.

The signal duration t_{AE} is the time difference between the time at which the amplitude of the signal exceeds a predefined threshold level for the last time during the burst event and the time at which the amplitude of the signal exceeds a predefined threshold level for the first time during the burst event.

The average frequency [symbol] f [symbol] is defined as the quotient between the number of threshold crossings N_{AE} and the signal duration t_{AE}, and is calculated as follows:

$$〈 f 〉 = {N}_{A E} / {t}_{A E} \qquad ( 1 )$$

The reverberation frequency fᵣₑᵥ is a measure of the reflections of the burst signal and is defined as follows:

$${f}_{r e v} = \frac{{N}_{A E} - {N}_{p e a k}}{{t}_{A E} - {t}_{p e a k}} , \qquad ( 2 )$$

wherein Nₚₑₐₖ is the number of threshold crossings until the time tₚₑₐₖ at which the peak amplitude Uₘₐₓ is reached.

The initiation frequency may be defined as

$${f}_{init} = \frac{{N}_{p e a k}}{{t}_{p e a k}} . \qquad ( 3 )$$

The peak frequency fₚₑₐₖ is the highest frequency of the frequency signal corresponding to the burst event, as shown in FIG. 7(b).

The spectral or frequency centroid f_{centroid}, which is shown in FIG. 7(b), corresponds to the center of mass of the spectrum of the burst signal and may be defined as

$${f}_{centroid} = \frac{\int f \cdot U ( f ) df}{\int U ( f ) d f} \qquad ( 4 )$$

wherein U(f) is the amplitude of the burst signal depending on the frequency.

The weighted peak frequency [symbol] fₚₑₐₖ [symbol] may be defined as

$$〈 {f}_{p e a k} 〉 = \sqrt{{f}_{p e a k} \cdot {f}_{centroid}} \qquad ( 5 )$$

The partial power is the percentage of power p in a given frequency range f₁-f₂ and may be defined as

$$p = {\int }_{{f}_{1}}^{{f}_{2}} {U}^{2} ( f ) df / \int {U}^{2} ( f ) d f \qquad ( 6 )$$

In the example of FIG. 7(b), a partial power 1 is calculated between 0 kHz and 150 kHz, a partial power 2 is calculated between 150 kHz and 300 kHz, a partial power 3 is calculated between 300 kHz and 450 kHz, a partial power 4 is calculated between 450 kHz and 600 kHz, a partial power 5 is calculated between 600 kHz and 750 kHz, and a partial power 6 is calculated between 750 kHz and 900 kHz.

The above features are merely illustrative and it is clear that further parameters may be extracted in order to characterize the failure modes.

In one example, a detection threshold is set such that the usual noise that is constantly present does not reach the detection threshold so as to avoid unnecessary analyses of events that are clearly not burst events.

The data acquisition device 40 may be configured to associate a failure mode to a detected burst event based on at least one of the above acoustic parameters. In particular, the data acquisition device 40 may be configured to associate at least a failure mode to a value of the at least one acoustic parameter to one or several types of failure. In one example, the data acquisition device 40 is configured to use a predictive model that links characteristics of the acoustic emission of the semiconductor device to one or several types of failure. In one example, the data acquisition device 40 is configured to associate the characteristics of the acoustic emission to the type of failure using a machine learning algorithm.

In one example, the predictive model is built during a plurality of training tests based at least on data acquired by the acoustic sensor 30 and, optionally, by the at least one further sensor 50. During a training test, at least one parameter of the environment may be controlled by the control device 21 according to a predetermined pattern and data are collected by the acoustic sensor 30 and, optionally, by the at least one further sensor 50. In addition, further data may be collected by other means, such as optical cameras, x-ray microscopy, scanning acoustic microscopy, or infrared thermography. In particular, during the test or at the end of the test, the probe comprising the semiconductor device 10 may be sent for failure analysis. When the failure analysis is carried out in the middle of the test, this means that the test has to be interrupted, the probe taken out of the system, analyzed, and mounted back into the system to continue the test. The type of failure may be determined based on at least some of the data collected from the acoustic sensor 30, the at least one further sensor 50 and the failure analysis.

In one example, a user overlays the different types of collected data with the data acquired by the acoustic sensor 30 and associates the type of failure with a particular burst event of the acoustic sensor signal. In one example, the user labels the type of failure with a corresponding label, such as crack or delamination. The label may also contain a location of the failure. In one example, the type of failure is associated with particular characteristics of the acoustic sensor signal. In particular, the acoustic sensor signal may be analyzed as set out above so as to yield various acoustic parameters. The type of failure may then be associated with particular values of the acoustic parameters determined above.

In one example, the predictive model is built with the help of a machine learning algorithm. The machine learning algorithm may receive, as inputs, the data acquired by the acoustic sensor 30, as well as at least some of the data acquired by the further sensor 50 and the failure analysis, and associate characteristics of the acoustic emission of the semiconductor device to a type of failure. The machine learning algorithm may be supervised or unsupervised.

When the machine learning algorithm is unsupervised, the algorithm uses only unlabeled data. The machine learning algorithm tries to find similarities, differences, patterns, and structure in the input data without any human intervention. The machine learning algorithm is then able to cluster datasets. When the number of features in the dataset is too high, the machine learning algorithm may reduce the number of data inputs to a manageable size, while preserving the integrity of the dataset as much as possible (so-called dimensionality reduction). This makes it possible to increase the speed and the performance of the fitting. Common unsupervised machine learning algorithms include hierarchical clustering, k-means clustering, density-based clustering with noise (DBSCAN), and ordering points to identify the clustering structure (OPTICS).

Supervised machine learning is a method in which at least some of the data fed to the algorithm are labeled by a user. For example, the user may indicate the type of failure associated with a particular set of data. The algorithm is able to learn patterns from these labeled data in order to classify data or predict failures more accurately. The algorithm assigns test data into specific categories. It recognizes specific entities within the dataset and attempts to draw conclusions as to how the entities should be labeled or defined. Common classification algorithms are linear classifiers, support vector machines, decision trees, k-nearest neighbor, and random forest. The algorithm may be adjusted until the model has been fitted appropriately. In one example, the user may verify the classification of the algorithm and confirm it or modify it.

The training data for the machine learning algorithms may be obtained during a plurality of training tests. Using machine learning has the advantage that the association between the acoustic parameters and the type of failure can be carried out efficiently and accurately. In particular, the huge number of data involved may be overwhelming to the single user.

During a reliability test, the data acquisition device 40 may use the predictive model created during the training tests to associate the acoustic sensor data to failure modes. With the system of FIG. 1, it is thus possible to determine and predict failure modes using only in situ real-time monitoring. In particular, failure modes can be recognized early. The disclosed system is particularly simple, quick and low-cost.

FIG. 2 shows a second example of a system 200 for monitoring failure modes in a semiconductor device 10. Compared with the system 100 of FIG. 1, the system 200 comprises a power supply 20 that is coupled to the semiconductor device 10. The power supply 20 is configured to apply a voltage or a current to the semiconductor device 10. The function of the system 200 is similar to that of the system 100 of FIG. 1. During a reliability test, the power supply 20 applies a voltage or a current to the semiconductor device 10 according to a predetermined pattern. The thermo-mechanical stress induced in the semiconductor device 10 by the voltage or the current leads to the generation of a failure in the semiconductor device 10 and, thus, to the emission of acoustic waves by the semiconductor device 10. These acoustic waves can be detected by the acoustic sensor 30 and the output of the acoustic sensor 30 can be analyzed by the data acquisition device 40.

In one example, the system 200 comprises a further sensor 50 which is configured to monitor at least one parameter of the semiconductor device 10. In one example, the further sensor 50 is configured to measure an electrical parameter of the semiconductor device 10, such as a current flowing though the semiconductor device 10 or a voltage between terminals of the semiconductor device 10. The further sensor 50 may be coupled to the power supply 20 to enable a feedback loop and, thus, a control of the voltage or of the current applied to one or several elements of the semiconductor device 10.

The system 200 of FIG. 2 may be combined with the system 100 of FIG. 1. In particular, the control device 21 of FIG. 1 may include a power supply 20. The further sensor 50 may include a plurality of sensors, wherein at least one sensor is configured to measure a temperature or a humidity of the semiconductor device 10, while another sensor is configured to measure a current through the semiconductor device 10 or a voltage at terminals of the semiconductor device 10. In addition, the data acquisition device 40 may receive, as inputs, in addition to the acoustic sensor data from the acoustic sensor 30, at least one of electrical data, temperature data and moisture data, wherein the data may be used to detect and classify failure modes of the semiconductor device 10.

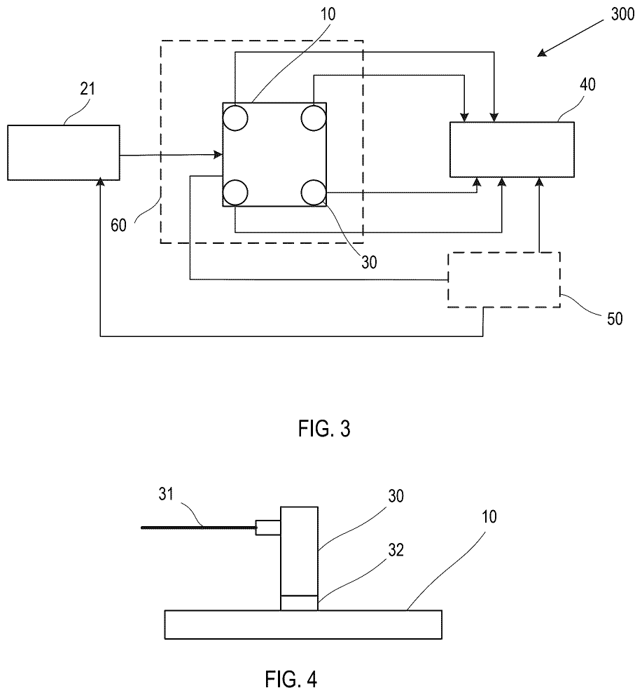

FIG. 3 shows a third example of a system 300 for monitoring failure modes in a semiconductor device 10. The system 300 is configured to determine, in addition to the characterization of the failure mode, a location of origin of the failure mode. Compared with the system 100 of FIG. 1, the system 300 comprises at least three acoustic sensors 30 that are arranged at different positions, each of which is coupled to the semiconductor device 10 and to the data acquisition device 40. In the depicted example, the system 300 comprises four acoustic sensors 30. Each acoustic sensor 30 is arranged at a corresponding edge of the quadratic semiconductor device 10. It is, however, clear to the skilled person that the number of the acoustic sensors is not limited to four and that the acoustic sensors may be arranged differently.

The data acquisition device 40 receives, as inputs, the outputs of each of the acoustic sensors 30. In one example, the data acquisition device 40 is further configured to determine a location of origin of the acoustic emission of the semiconductor device 10 based on the outputs of the acoustic sensors 30.

The acoustic waves generated by the semiconductor device 10 are emitted in different directions. When a failure occurs in the semiconductor device 10 and acoustic waves are emitted, they are detected by each of the acoustic sensors 30. However, due to the different locations of the acoustic sensors 30, the acoustic waves, which have a specific location of origin, will reach the acoustic sensors 30 at different times.

In one example, the data acquisition device 40 is configured to determine a location of origin of an acoustic emission based on a time difference between the acoustic signals of the acoustic sensors 30. Since there are at least three acoustic sensors 30, the data acquisition device 40 may carry out a simple triangulation to obtain the location of the failure based on the differences of the time arrival between the acoustic sensors 30.

Determining the location of origin using a plurality of acoustic sensors 30 can be particularly useful when creating and training a predictive model during training tests. In one example, the determined type of failure is also labeled with the determined location of origin of the acoustic emission of the semiconductor device.

Several modifications can be made to the systems of FIGS. 1 to 3 without departing from the scope of the appended claims. In particular, the system may comprise a plurality of semiconductor devices 10, wherein each semiconductor device 10 is coupled to at least one corresponding acoustic sensor 30 and each acoustic sensor 30 is coupled to the data acquisition device 40. The semiconductor devices 10 may be coupled to a single control device or to a single power supply, which is configured to modify at least one parameter of the semiconductor devices 10. In one example, the parameter is controlled identically for all semiconductor devices 10. In another example, the parameters are controlled independently of each other for the different semiconductor devices 10. The semiconductor devices 10 may all be arranged within the same test chamber.

FIG. 4 shows an example, in a side view, of a coupling between the semiconductor device 10 and the acoustic sensor 30. In the depicted example, the semiconductor device 10 is coupled to the acoustic sensor 30 via an acoustic coupler element 32. The acoustic coupler element 32 is configured to efficiently transmit acoustic emissions from the semiconductor device 10 to the acoustic sensor 30. The acoustic coupler element 32 may be made of silicone. The acoustic sensor 30 may be arranged on a top surface of the semiconductor device 10. In the depicted example, the system comprises a single acoustic sensor 30 that is arranged at the center of the semiconductor device 10. However, the number of acoustic sensors is not limited to one, and the acoustic sensor 30 does not need to be arranged at the center. In the depicted example, the acoustic sensor 30 is configured to receive and send data via an acoustic sensor cable 31. In one example, the acoustic sensor 30 sends the acoustic signal to the data acquisition device 40 via the cable 31.

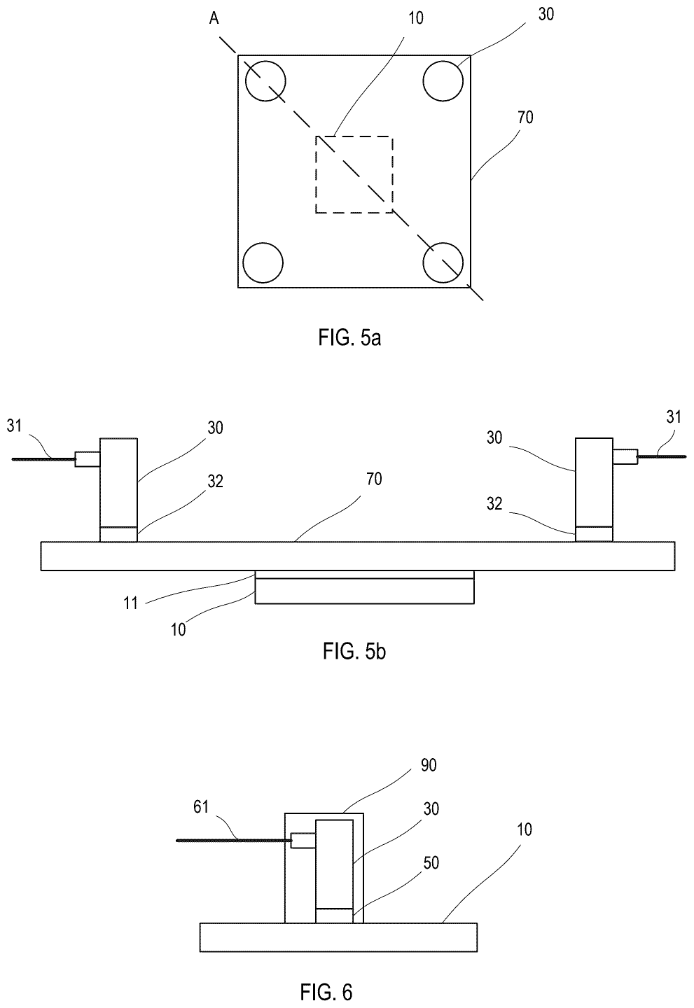

In the example of FIG. 4, the basis area of the acoustic sensor 30 is less than that of the semiconductor device 10. However, this is not always the case. In particular when the number of acoustic sensors is superior to one, there might be some issues with the arrangement of the acoustic sensors 30. Such a situation is depicted in FIGS. 5a and 5b.

FIG. 5 shows an example of a coupling between a semiconductor device 10 and a plurality of acoustic sensors 30. FIG. 5a shows a view from above of the arrangement and FIG. 5b shows a side view. In this example, the total area of the acoustic sensors 30 is larger than that of the semiconductor device 10, thereby impeding that the acoustic sensors 30 all be arranged on the semiconductor device 10. In the example of FIG. 5, the arrangement comprises one semiconductor device 10, four acoustic sensors 30, and an interposer 70 (substrate). The interposer 70 is a plate element having a top and a bottom surface. The semiconductor device 10 is arranged on the bottom surface of the interposer 70 via a first acoustic coupler element 11. The acoustic sensors 30 are arranged on the top surface of the interposer 70 via corresponding acoustic coupler elements 32. Each acoustic sensor 30 is coupled to a cable 31 for receiving and sending data. In the depicted example, the semiconductor device 10 is arranged at the center of the interposer 70, while the acoustic couplers are each arranged at different locations at the edge of the interposer 70. The interposer 70 is made of a material that is configured to efficiently transmit the acoustic emissions of the semiconductor device 10. The interposer 70 thus makes it possible to expand the surface area of the semiconductor device 10. With this, it is possible to arrange a plurality of acoustic sensors 30 while keeping the arrangement particularly compact. It is also possible to arrange acoustic sensors 30 even when the semiconductor device 10 to be monitored has a small area. It is clear to the skilled person that the depicted arrangement may also comprise a different number of acoustic sensors depending on the requirements of the test.

In the examples above, the acoustic sensor 30 is arranged in the same environment as the semiconductor device 10. During the tests, the semiconductor device 10 may be subjected to different kinds of stress. In particular, the temperature of the environment during a thermal cycling process may change from a very low temperature to a very high temperature. However, the performance of the acoustic sensors 30 may be affected by high changes of temperature. It may thus be necessary to protect them against the environment during the tests.

FIG. 6 shows a further example, in a side view, of a coupling between the semiconductor device 10 and the acoustic sensor 30. Compared with the embodiment of FIG. 4, the acoustic sensor 30 is covered with a protective coating 90 that is configured to protect the acoustic sensor 30 against environmental conditions. Further, the acoustic sensor cable 61 with which the acoustic sensor 30 receives and sends data may also be covered with the protective coating 90. The material of the protective coating 90 may be any of the following: an aerogel jelly, an aerogel, neoprene, and a microporous insulation. However, the material is the protective coating 90 is not restricted to this list. With the protective coating 90, the acoustic sensor 30 can be efficiently protected against changes in the environment during the test so that the efficiency of the acoustic sensor 30 is not damaged and a good data transmission to the data acquisition device 40 can be ensured.

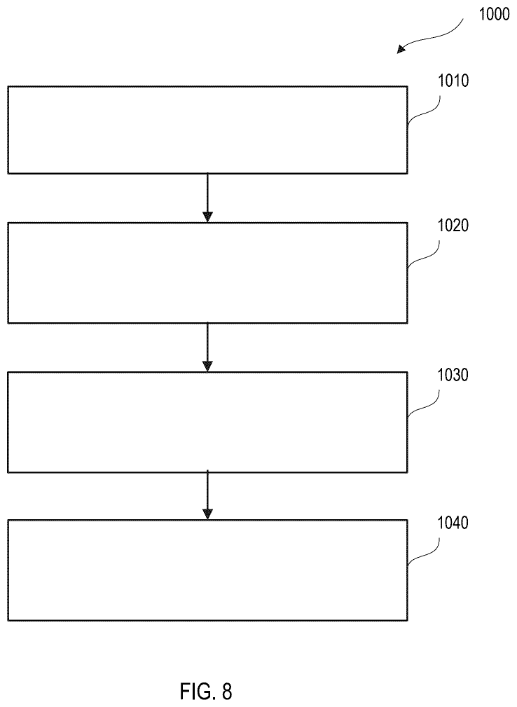

FIG. 8 is a flowchart illustrating an example method 1000 for creating a predictive model for predicting failure modes in a semiconductor device.

The example process 1000 can be employed to operate devices illustrated in this disclosure, such as the systems according to FIGS. 1, 2 and 3.

Process 1000 comprises providing a semiconductor device 10 that is coupled to at least one acoustic sensor 30. The at least one acoustic sensor 30 is configured to detect acoustic waves generated by the semiconductor device 10 when it is under stress, such as any electro-mechanical stress. In one example, the semiconductor device 10 is a packaged power semiconductor component that comprises at least one transistor. In one example, the semiconductor device 10 comprises a plurality of semiconductor devices, wherein each semiconductor device 10 is coupled to at least one acoustic sensor 30. In one example, the acoustic sensor 30 is a piezo-electric sensor. In one example, the acoustic sensor 30 is coupled to the semiconductor device 10 via an acoustic coupler element. In another example, the semiconductor device 10 is arranged on a first surface of an interposer 70 and the at least one acoustic sensor 30 is arranged a second surface of the interposer 70 that is opposite the first surface. With this, it is possible to couple the at least one acoustic sensor 30 to the semiconductor device 10 even when the surface area of the semiconductor device 10 is not sufficient to accommodate the at least one acoustic sensor 30. The interposer 70 is made of a material with good acoustic conduction properties. In another example, the number of acoustic sensors 30 is four, wherein the semiconductor device 10 is arranged at the center of the interposer 70 and the acoustic sensors are arranged at an edge of the interposer 70. In one example, the number of acoustic sensors 30 is at least three. The acoustic sensors 30 are arranged at different positions with regard to the semiconductor device 10. In one example, the semiconductor device 10 is arranged in a closed chamber, such as a test chamber 60. In one example, the acoustic sensor 30 is covered with a protective coating 90.

The process 1000 further comprises modifying, during a training test, at least one first parameter of the semiconductor device 10. In one example, the parameter is temperature or moisture. The test is then said to be a passive test. The semiconductor device 10 may be coupled to a control device 21 that is configured to control the parameter. The parameter may be monitored by a corresponding sensor, such as a temperature sensor or a moisture sensor, wherein an output of the sensor is sent to the control device 21 and used to control the parameter. In another example, the parameter is an electrical parameter. A voltage or a current may be applied to the semiconductor device 10, for example by a corresponding power supply 20. In another example, the parameters may be a combination of temperature, moisture and electrical parameters. The test is then said to be an active test. In one example, the parameter is modified according to a predetermined pattern. The pattern may comprise a series of cycles in which the parameter is changed from a low value to a high value and back to the low value. In another example, the parameter is modified so as to imitate typical working conditions of the semiconductor device 10. In one example, several parameters are modified at the same time.

Further, the process 1000 comprises acquiring, by the at least one acoustic sensor 30, first sensor data that represent an acoustic emission of the semiconductor device 10, wherein the acoustic emission is linked to a failure of the semiconductor device 10 that is at least partly caused by the modification of the at least one first parameter. Modifying the at least one parameter leads to thermo-mechanical stress in the semiconductor device 10. The stress can lead to the formation of a failure in the semiconductor device 10 at a specific location, such as a crack or a delamination. The generation and propagation of the failure leads to the release of an acoustic wave that can be detected by the acoustic sensor 30. In one example, the acoustic sensor 30 is connected to a data acquisition device 40 via an acoustic sensor cable 31, 61 and sends the first sensor data to the data acquisition device 40 via the acoustic sensor cable 31, 61. The acoustic sensor cable 61 may be covered with a protective coating 90.

The process 1000 also comprises associating characteristics of the acoustic emission of the semiconductor device 10 to a type of failure based at least on the first sensor data. In one example, at least one acoustic parameter is extracted from the first sensor data. The acoustic parameter may be calculated from the first sensor data in the time domain or in the frequency domain. The acoustic parameters characterize a behavior of the first sensor data when an acoustic wave is emitted (burst event). The at least one acoustic parameter may be chosen from the group consisting of: a burst signal peak amplitude, a burst signal rise-time, a ring-down count, a signal duration, an average frequency, a reverberation frequency, an initiation frequency, a peak frequency, a spectral centroid, a weighted peak frequency, and a partial power in a given frequency range. These parameters are defined earlier in the application. In one example, a value of the at least one acoustic parameter is associated to the type of failure.

In one example, the characteristics of the acoustic emission of the semiconductor device 10 are associated to a type of failure based on the first sensor data and on further data. Although the acoustic emissions are able to provide important information about possible failures in the semiconductor device 10, they are, alone, difficult to interpret. For this reason, it may be helpful to compare and overlay the acoustic sensor data with other data in order to be able to define the exact type of failure. The further data may be second sensor data collected by additional sensors that are configured to monitor in situ a parameter of the semiconductor device 10 during a test. They represent one or more second parameters of the semiconductor device 10. In one example, the second sensor data are indicative of electrical parameters or thermal parameters. The further data may also be failure data collected during a failure analysis. They are indicative of the presence of a failure in the semiconductor device 10 and of the type of the failure. For this purpose, the semiconductor device 10 may be, during the test or at the end of the test, removed from the test setup and analyzed, before being placed back into the setup. If the test has been interrupted, it may then be resumed. Failure analysis may be carried out by at least one the following measurement devices: optical microscopy, x-ray microscopy, scanning acoustic microscopy, scanning electron microscopy, focused ion beam, infrared thermography, decapsulation for electronic component testing, cross-sectional analysis or fault location techniques. They provide additional information about interfaces within the semiconductor device and the type of failure. It is then possible to associate the information gained with the acoustic sensors 30 with the information gained from other sensors. In one example, the failure is labeled by a user based on the first sensor data and the further data. The label may contain an indication of the type of failure, such as crack or delamination, as well as an indication of the location of the failure.

In one example, the location of origin of the acoustic emission of the semiconductor device is determined, and associating characteristics of the acoustic emission of the semiconductor device 10 to a type of failure is further based on the determined location of origin. In one example, the semiconductor device 10 is coupled to at least three acoustic sensors 30 that are arranged at different positions and the determination of the location of origin of the acoustic emission of the semiconductor device 10 is based on outputs of the at least three acoustic sensors 30. Acoustic waves are emitted in all directions and can, thus, be detected by all the acoustic sensors 30. However, since the acoustic sensors 30 are arranged at different positions, the acoustic waves will reach the acoustic sensors 30 at different times. It is then possible to obtain the location of the origin of the acoustic waves by comparing the first sensor data of the acoustic sensors 30 based on a difference of time of arrival of the acoustic waves. The information on the location of the failure may also be derived from the further sensor data, in particular from the failure analysis. In one example, the type of failure is labeled with the determined location of origin of the acoustic emission of the semiconductor device 10.

In one example, the first sensor data, and optionally the second sensor data or the failure data, are input to a machine learning algorithm and a predictive model is built by the machine learning algorithm that associates the characteristics of the acoustic emission of the semiconductor device 10 to the type of failure based on the first sensor data and, optionally, on the further data. The machine learning algorithm is configured to automatically classify the types of failure based on the input data. In one example, the data input to the machine learning algorithm are not labeled and the machine learning algorithm compares the various sets of data and tries to find similarities, differences, patterns, and structure in the input data. The machine learning algorithm eventually clusters datasets. In another example, the data input to the machine learning algorithm are already labeled by the user, for example based on an analysis of at least some of the data. The algorithms is trained to classify data or predict outcomes accurately.

In one example, the predictive model is based on various sets of first sensor data obtained during a plurality of training tests. The predictive model can then be used to detect a failure and determine a type of failure.

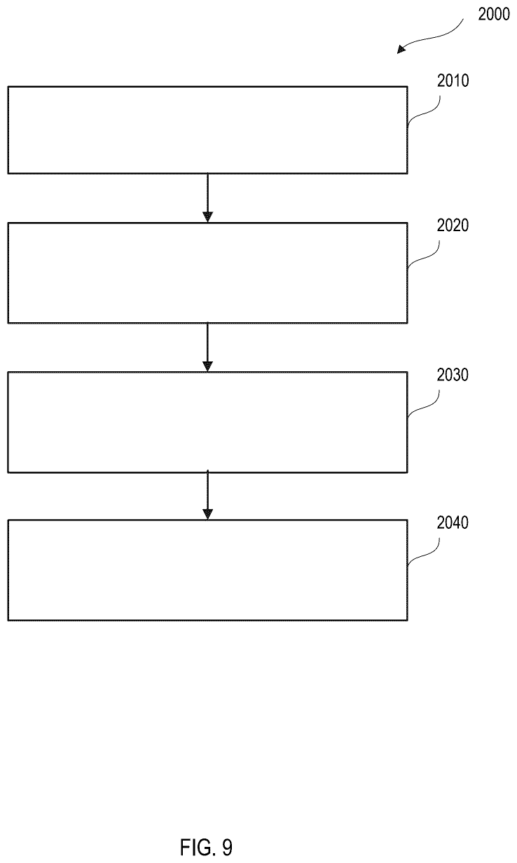

FIG. 9 is a flowchart illustrating an example method 2000 for predicting failure modes in a semiconductor device.

The example process 2000 can be employed to operate devices illustrated in this disclosure, such as the systems according to FIGS. 1, 2 and 3.

Process 2000 comprises providing a semiconductor device 10 that is coupled to at least one acoustic sensor 30. The acoustic sensor 30 may be arranged on the semiconductor device 10. In one example, the semiconductor device 10 and the acoustic sensor 30 are both arranged on an interposer 70. In one example, the acoustic sensor 30 is coupled to the semiconductor device 10 via an acoustic coupler element 32. The semiconductor device 10 may be coupled to at least three acoustic sensors 30. With this, it is possible to also determine an exact location of a failure.

The process 2000 also comprises outputting, by the at least one acoustic sensor 30, a sensor signal representing an acoustic emission of the semiconductor device 10. When a failure occurs in the semiconductor device 10, acoustic waves are emitted that can be detected by the acoustic sensor 30. In one example, the semiconductor device 10 is stressed by modifying at least one parameter of the semiconductor device 10. The parameter may be temperature, humidity or an electrical parameter, such as a voltage applied to the semiconductor device 10 or a current flowing through the semiconductor device 10. In one example, the parameter is controlled via a control device 20. In one example, a power supply 20 is provided which can apply a voltage or a current to the semiconductor device 10. In one example, the acoustic sensor 30 sends the sensor signal to a data acquisition device 40 that is configured to analyze the sensor signal. The acoustic sensor 30 may send the sensor signal via an acoustic sensor cable 31, 61.

The process 2000 further comprises, based on at least the sensor signal, detecting the presence of a failure of the semiconductor device 10 and, in the event that the presence of a failure is detected, determining a type of failure. In one example, at least one acoustic parameter based on the sensor signal is calculated and the detection of the presence of the failure and the determination of the type of failure are based at least on a value of the at least one acoustic parameter. The at least one acoustic parameter may be chosen from the group consisting of: a burst signal peak amplitude, a burst signal rise-time, a ring-down count, a signal duration, an average frequency, a reverberation frequency, an initiation frequency, a peak frequency, a spectral centroid, a weighted peak frequency, and a partial power in a given frequency range. These parameters are defined above in the application.

In one example, the steps of detecting the presence of a failure of the semiconductor device 10 and of determining a type of failure are further based on a predictive model that is configured to associate characteristics of the acoustic emission of the semiconductor device 10 to a type of failure. In one example, the predictive model is built using the method 1000 illustrated in FIG. 8. In one example, the predictive model is built by a supervised machine learning algorithm. A supervised machine learning algorithm is an algorithm to which previously labeled data are fed. The data may be labeled by a user based on the analysis of failure data.

In one example, the process 2000 also comprising determining a location of the failure based at least on the sensor signal. In one example, the determination of the location of the failure is carried out by the machine learning algorithm. In another example, the determination of the location of the failure is obtained by comparing sensor signals from at least three acoustic sensors 30 arranged at different positions.

The present application describes a system for detecting and determining failures modes in a semiconductor device, in particular in semiconductor packaged devices. With previous techniques, determining failure modes of a semiconductor device is particularly costly and time-consuming. This problem is solved by integrating acoustic emission monitoring to reliability testing of semiconductor and semiconductor packaged devices. The system of the application comprises at least one acoustic sensor that is coupled to the semiconductor device and that provides information that can be used to gain insight on the failure modes. In particular, the acoustic emissions detected by the acoustic sensor can be used to characterize and locate failures of the semiconductor device. By using information coming from the acoustic emission signal alone, such as features extracted from the time and frequency domains during a burst event, or in combination with information coming from other sources (e.g., failure analysis, electrical parameters), it is possible to establish and detect patterns in the failure modes, as well as train algorithms to classify signal and predict failure modes accurately. Further, the acoustic emission signal makes it possible to pinpoint the origin of the acoustic emissions in the semiconductor device. The location of the failure can then be linked to the failure modes by additional analysis. With the described system, it is possible to classify the failure modes and to build a predictive model that associates characteristics of the acoustic emissions to a failure mode. Machine learning algorithms can help build the predictive model efficiently. The predictive model can then be used to determine failure modes during reliability tests.

Acoustic emission monitoring is a non-destructive and relative low-cost test technique. It makes it possible to continuously monitor failure modes in real-time and in situ, which cannot be done with usual failure analysis techniques. In particular, using acoustic emission make it possible to detect failure modes early so as to be able to respond more quickly to a failure. Further, it makes it possible to determine precisely when the failure mode happens, thereby rendering a statistical treatment of the data, such as a lifetime modelling, possible. With the systems and methods described in the application, it is also possible to identify weak spots in a semiconductor device during the development of new packages, thereby reducing the number of learning cycles. The analysis of the acoustic emissions provides a deeper understanding of failure modes, in particular about the generation and growth of defects in a semiconductor device, and reduces the need for additional analysis. In addition, intermediate read-outs and unnecessary handling of the semiconductor during a test can be avoided. This reduces the test time, avoids idle equipment time, requires less human resources and avoids causing failure modes caused during intervention. The techniques described in the application thus make it possible to predict failure modes in a more accurate and quicker manner and at a low cost.

Although various embodiments have been illustrated and described with respect to one or more specific implementations, alterations and/or modifications may be made to the illustrated examples without departing from the spirit and scope of the features and structures recited herein. With particular regard to the various functions performed by the above described components or structures (units, assemblies, devices, circuits, systems, etc.), the terms (including a reference to a “means”) used to describe such components are intended to correspond—unless otherwise indicated—to any component or structure that performs the specified function of the described component (e.g., that is functionally equivalent), even if it is not structurally equivalent to the disclosed structure that performs the function in the herein illustrated exemplary implementations of the present disclosure.

Although the present disclosure is not so limited, the following numbered examples demonstrate one or more aspects of the disclosure.

Example 1. A method (1000), comprising: providing (1010) a semiconductor device (10) that is coupled to at least one acoustic sensor (30); modifying (1020), during a training test, at least one first parameter of the semiconductor device (10); acquiring (1030), by the at least one acoustic sensor (30), first sensor data that represent an acoustic emission of the semiconductor device (10), wherein the acoustic emission is linked to a failure of the semiconductor device (10) that is at least partly caused by the modification of the at least one first parameter; associating (1040) characteristics of the acoustic emission of the semiconductor device (10) to a type of failure based at least on the first sensor data.

Example 2. The method of example 1, wherein the at least one parameter is at least one of: temperature and moisture.

Example 3. The method of example 1 or 2, further comprising: applying a voltage or a current to the semiconductor device (10), wherein the at least one parameter is an electrical parameter.

Example 4. The method of any one of examples 1 to 3, wherein the at least one parameter is modified according to a predetermined pattern.

Example 5. The method of any one of examples 1 to 4, wherein the semiconductor device (10) is arranged in a closed chamber (60).

Example 6. The method of any one of examples 1 to 5, wherein the step of associating (1040) characteristics of the acoustic emission of the semiconductor device (10) to a type of failure is further based on failure data obtained by failure analysis, wherein the failure data are indicative of the presence of a failure in the semiconductor device and of the type of the failure.

Example 7. The method of example 6, wherein the failure data are obtained by scanning acoustic microscopy.

Example 8. The method of any one of examples 1 to 7, further comprising: acquiring, by at least one further sensor (50), second sensor data that represent one or more second parameters of the semiconductor device (10), wherein the step of associating (1040) characteristics of the acoustic emission of the semiconductor device (10) to a type of failure is further based on the second sensor data.

Example 9. The method of example 8, wherein the second sensor data are indicative of electrical parameters or thermal parameters.

Example 10. The method of any one of examples 1 to 9, further comprising: inputting, to a machine learning algorithm, at least the first sensor data and building, by the machine learning algorithm, a predictive model that associates the characteristics of the acoustic emission of the semiconductor device (10) to the type of failure.

Example 11. The method of example 10, further comprising: labeling, by a user, the first sensor data with labels indicating the type of failure, wherein the machine learning algorithm further receives as inputs the labels.

Example 12. The method of example 10, wherein the first sensor data, which are input to the machine learning algorithm, are unlabeled.

Example 13. The method of any one of examples 10 to 12, wherein the predictive model is based on various sets of first sensor data obtained during a plurality of training tests.

Example 14. The method of any one of examples 1 to 13, further comprising: calculating at least one acoustic parameter from the first sensor data, wherein the step of associating (1040) characteristics of the acoustic emission of the semiconductor device (10) to a type of failure based at least on the first sensor data comprises associating a value of the at least one acoustic parameter to the type of failure.

Example 15. The method of example 14, wherein the at least one acoustic parameter is chosen from the group consisting of: a burst signal peak amplitude, a burst signal rise-time, a ring-down count, a signal duration, an average frequency, a reverberation frequency, an initiation frequency, a peak frequency, a spectral centroid, a weighted peak frequency, and a partial power in a given frequency range.

Example 16. The method of any one of examples 1 to 15, further comprising: determining a location of origin of the acoustic emission of the semiconductor device (10), wherein the step of associating (1040) characteristics of the acoustic emission of the semiconductor device (10) to a type of failure is further based on the determined location of origin.

Example 17. The method of example 16, wherein the semiconductor device (10) is coupled to at least three acoustic sensors (30) that are arranged at different positions, wherein the step of determining a location of origin of the acoustic emission of the semiconductor device (10) is based on outputs of the at least three acoustic sensors (30).

Example 18. The method of example 16 or 17, further comprising: labeling the type of failure with the determined location of origin of the acoustic emission of the semiconductor device (10).

Example 19. A method (2000), comprising: providing (2010) a semiconductor device (10) that is coupled to at least one acoustic sensor (30); outputting (2020), by the at least one acoustic sensor (30), a sensor signal representing an acoustic emission of the semiconductor device (10); and based on at least the sensor signal: detecting (2030) the presence of a failure of the semiconductor device (10) and, in the event that the presence of a failure is detected, determining (2040) a type of failure.

Example 20. The method of example 19, wherein the steps of detecting (2030) the presence of a failure of the semiconductor device (10) and of determining (2040) a type of failure are further based on a predictive model that is configured to associate characteristics of the acoustic emission of the semiconductor device (10) to a type of failure.

Example 21. The method of example 20, wherein the predictive model is built using a supervised machine learning algorithm.

Example 22. The method of example 20 or 21, further comprising calculating at least one acoustic parameter based on the sensor signal, wherein the steps of detecting (2030) the presence of a failure of the semiconductor device (10) and of determining (2040) a type of failure are further based at least on a value of the at least one acoustic parameter.

Example 23. The method of example 22, wherein the at least one acoustic parameter is chosen from the group consisting of: a burst signal peak amplitude, a burst signal rise-time, a ring-down count, a signal duration, an average frequency, a reverberation frequency, an initiation frequency, a peak frequency, a spectral centroid, a weighted peak frequency, and a partial power in a given frequency range.

Example 24. A system (100) comprising: a semiconductor device (10); at least one acoustic sensor (30) coupled to the semiconductor device (10) and configured to output a first sensor signal representing an acoustic emission of the semiconductor device (10); and a processor configured to: receive, as input, at least the first sensor signal, and based on at least the first sensor signal: detect the presence of a failure of the semiconductor device (10) and, in the event that the presence of a failure is detected, determine a type of failure.

Example 25. The system (100) of example 24, wherein the acoustic sensor (30) is a piezo-electric sensor.

Example 26. The system (100) of example 24 or 25, wherein the acoustic sensor (30) is coupled to the semiconductor device (10) via an acoustic coupler element (32).

Example 27. The system (100) of any one of examples 24 to 26, further comprising: at least three acoustic sensors (30) arranged at different positions, wherein the processor is further configured to determine an origin of the acoustic emission of the semiconductor device based on the outputs of the at least three acoustic sensors (30).

Example 28. The system (100) of any one of examples 24 to 27, further comprising an interposer (70), wherein the semiconductor device (10) and the at least one acoustic sensor (30) are coupled to the interposer (70) via corresponding acoustic couplers (10, 32).

Example 29. The system (100) of any one of examples 24 to 28, wherein the at least one acoustic sensor (30) is covered with a protective coating (90) that is configured to protect the acoustic sensor (30) against environmental conditions.

Example 30. The system (100) of example 29, wherein the at least one acoustic sensor (30) is configured to receive and send data via an acoustic sensor cable (61), wherein the acoustic sensor cable (61) is also covered with the protective coating (90).

Example 31. The system (100) of any one of examples 24 to 30, wherein the semiconductor device (10) is a packaged power semiconductor component that comprises at least one transistor.

Example 32. The system (100) of any one of examples 24 to 31, wherein the semiconductor device (10) is arranged in a closed chamber (60).

Example 33. The system (100) of any one of examples 24 to 32, further comprising: a power supply (20) configured to apply a voltage or a current to the semiconductor module (10).

Example 34. The system (100) of any one of examples 24 to 33, wherein the processor is further configured to associate, based at least on the first sensor signal, characteristics of the acoustic emission of the semiconductor device (10) to a type of failure based at least on the first sensor data.

Example 35. The system (100) of any one of examples 24 to 34, further comprising: at least a further sensor (50) that is configured to monitor one or more parameters of the semiconductor device (10) and to output a second sensor signal, wherein the steps of detecting the presence of a failure of the semiconductor device (10) and determining a type of failure are further based on the second sensor signal.

Example 36. The system (100) according to example 35, wherein the one or more parameters are electrical parameters or thermal parameters.

Example 37. The system (100) of examples 35 or 36, wherein the processor is further configured to associate, based at least on the first sensor signal and on the second sensor signal, characteristics of the acoustic emission of the semiconductor device (10) to a type of failure based at least on the first sensor data.

Example 38. The system (100) of example 37, wherein the processor is configured to associate the characteristics of the acoustic emission to the type of failure using a machine learning algorithm.

Example 39. The system (100) of any one of examples 24 to 38, wherein the processor is further configured to detect the presence of a failure and determine a type of failure based on the first sensor signal and on a predictive model that is configured to associate characteristics of the acoustic emission to a type of failure.

Example 40. The system (100) any one of examples 24 to 39, wherein the processor is further configured to: calculate at least one acoustic parameter based on the first sensor signal, and based at least on the at least one acoustic parameter, detect the presence of a failure of the semiconductor device and, in the event that the presence of a failure is detected, determine a type of failure.

Example 41. The system (100) of example 40, wherein the at least one acoustic parameter is chosen from the group consisting of: a burst signal peak amplitude, a burst signal rise-time, a ring-down count, a signal duration, an average frequency, a reverberation frequency, an initiation frequency, a peak frequency, a spectral centroid, a weighted peak frequency, and a partial power in a given frequency range.

1. A method, comprising:
providing a semiconductor device that is coupled to at least one acoustic sensor;
modifying, during a training test, at least one first parameter of the semiconductor device;
acquiring, by the at least one acoustic sensor, first sensor data that represents an acoustic emission of the semiconductor device, wherein the acoustic emission is linked to a failure of the semiconductor device that is at least partly caused by the modification of the at least one first parameter; and
associating characteristics of the acoustic emission of the semiconductor device to a type of failure based at least on the first sensor data.

2. The method of claim 1,
wherein the at least one parameter is at least one of: temperature and moisture.

3. The method of claim 1, further comprising:
applying a voltage or a current to the semiconductor device,
wherein the at least one parameter is an electrical parameter.

4. The method of claim 1,
wherein the step of associating characteristics of the acoustic emission of the semiconductor device to a type of failure is further based on failure data obtained by failure analysis, wherein the failure data are indicative of the presence of a failure in the semiconductor device and of the type of the failure.

5. The method of claim 1, further comprising:
acquiring, by at least one further sensor, second sensor data that represents one or more second parameters of the semiconductor device,
wherein the step of associating characteristics of the acoustic emission of the semiconductor device to a type of failure is further based on the second sensor data.

6. The method of claim 1, further comprising:
inputting, to a machine learning algorithm, at least the first sensor data and building, by the machine learning algorithm, a predictive model that associates the characteristics of the acoustic emission of the semiconductor device to the type of failure.

7. The method of claim 6, further comprising:
labeling, by a user, the first sensor data with labels indicating the type of failure, wherein the machine learning algorithm further receives as inputs the labels.

8. The method of claim 1, further comprising:
calculating at least one acoustic parameter from the first sensor data,
wherein the step of associating characteristics of the acoustic emission of the semiconductor device to a type of failure based at least on the first sensor data comprises associating a value of the at least one acoustic parameter to the type of failure.

9. The method of claim 1, further comprising:
determining a location of origin of the acoustic emission of the semiconductor device,
wherein the step of associating characteristics of the acoustic emission of the semiconductor device to a type of failure is further based on the determined location of origin.

10. The method of claim 9,
wherein the semiconductor device is coupled to at least three acoustic sensors that are arranged at different positions,
wherein the step of determining a location of origin of the acoustic emission of the semiconductor device is based on outputs of the at least three acoustic sensors.

11. A method, comprising:
providing a semiconductor device that is coupled to at least one acoustic sensor;
outputting, by the at least one acoustic sensor, a sensor signal representing an acoustic emission of the semiconductor device; and
based on at least the sensor signal:
detecting a presence of a failure of the semiconductor device and,
in the event that the presence of a failure is detected, determining a type of failure.

12. The method of claim 11,
wherein the steps of detecting the presence of a failure of the semiconductor device and of determining a type of failure are further based on a predictive model that is configured to associate characteristics of the acoustic emission of the semiconductor device to a type of failure.

13. The method of claim 11, further comprising
calculating at least one acoustic parameter based on the sensor signal,
wherein the steps of detecting the presence of a failure of the semiconductor device and of determining a type of failure are further based at least on a value of the at least one acoustic parameter.

14. A system comprising:
a semiconductor device;
at least one acoustic sensor coupled to the semiconductor device and configured to output a first sensor signal representing an acoustic emission of the semiconductor device; and
a processor configured to:
receive, as input, at least the first sensor signal, and
based on at least the first sensor signal:
detect the presence of a failure of the semiconductor device and,
in the event that the presence of a failure is detected, determine a type of failure.

15. The system of claim 14,
wherein the acoustic sensor is coupled to the semiconductor device via an acoustic coupler element.

16. The system of claim 14, further comprising:
at least three acoustic sensors arranged at different positions,
wherein the processor is further configured to determine an origin of the acoustic emission of the semiconductor device based on the outputs of the at least three acoustic sensors.

17. The system of claim 14, further comprising
an interposer, wherein the semiconductor device and the at least one acoustic sensor are coupled to the interposer via corresponding acoustic couplers.

18. The system of claim 14,
wherein the at least one acoustic sensor is covered with a protective coating that is configured to protect the acoustic sensor against environmental conditions.

19. The system of claim 14, further comprising:
a power supply configured to apply a voltage or a current to the semiconductor module.

20. The system of claim 14, further comprising:
at least a further sensor that is configured to monitor one or more parameters of the semiconductor device and to output a second sensor signal,
wherein the steps of detecting the presence of a failure of the semiconductor device and determining a type of failure are further based on the second sensor signal.
